(19) United States
(12) Patent Application Publication
(10) Pub. No.: US 2008/0258930 A1
(43) Pub. Date: Oct. 23, 2008

(54) PERMISSION BASED RFID TAG

(76) Inventors: Glenn A. Demichele, Lincolnshire, IL (US); Douglas Alexander Kerns, Sierra Madre, CA (US); David Eamon Detlefsen, Arlington Heights, IL (US)

Correspondence Address: DON W. WEBER, 235 BRISTOL, TROY, IL, 62294, US

(21) Appl. No.: 11/737,893

(22) Filed: Apr. 20, 2007

(51) Int. Cl. G08B 6/00

(52) U.S. Cl. 340/691.1

(57) ABSTRACT

An implantable, readable miniature transponder has an antenna coupled to a microchip integrated circuit. The integrated circuit has unique identifying information stored in the chip. The integrated circuit microchip also has control logic, a muscle stimulator, an EMG amplifier and a data transmitter. The integrated circuit is connected to the antenna and to muscle electrodes that have EMG sensors. When an external reader illuminates the transponder the control logic alerts the implanted subject and inhibits any data from being sent to the reader. Through a series of predetermined voluntary muscle contractions the subject sends a signal to the control logic to either allow or deny the reader access to the identifying information.

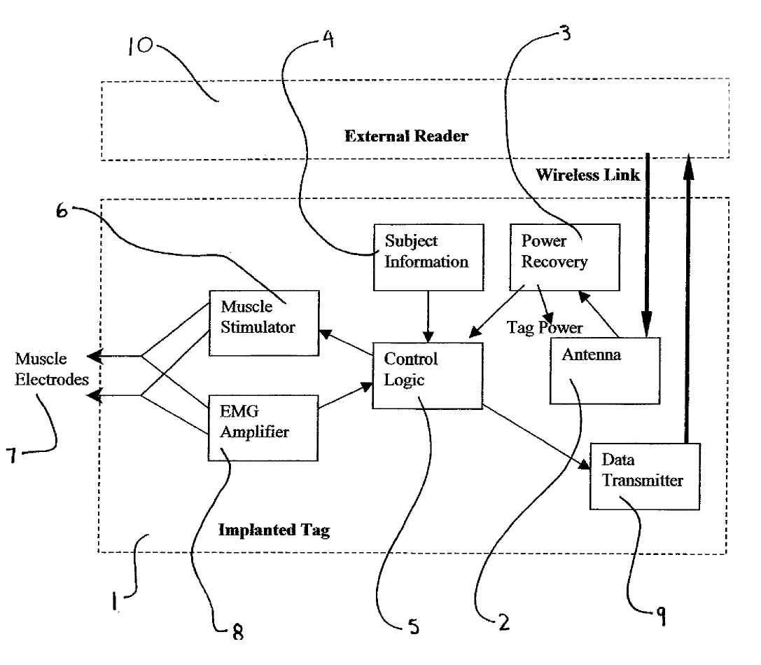

### BACKGROUND OF THE INVENTION

This invention relates to the field of RFID tags. More specifically, a device is described which allows a person to allow or deny access to a personal identification tag.

The field of electronic identification of objects has been growing in recent years. With the introduction of bar codes, the identification and inventory of objects has been advanced. Using a unique bar code, an object can be scanned into a computer. The computer can make various uses of the identified code, including pricing and inventory. The technology for using bar codes is well known in the art.

Another type of electronic identification comprises small transponders that may be placed inside in an inanimate object such as a car, shirt or tool. Other identification transponders may be implantable into live targets such as livestock, pets or laboratory animals. The transponders provide a convenient and almost fool proof method of identifying and keeping track of the objects or animals.

Some transponders are “active,” having a power source of their own integrated into the circuitry. The active transponders normally are not small enough to be implantable. “Passive” transponders are capable of being built in a very small package. Passive implantable transponders used for identification purposes are often the size of a grain of rice. The passive transponders receive their power from the interrogator that not only powers the passive transponder but also reads the reply data from the implanted identification device.

An electronic identification system has several components. These include the RFID tag itself, an interrogation means (a reader) and a component that turns raw information (usually voltages) into data.

The identification tag contains an antenna, an integrated circuit containing unique identification data and receive/reply electronic circuitry. This receive/reply circuitry is well known in the art and may take many forms, depending on the precise requirements of the task. Different tags are known in the art. They include microchips that store the unique identifiers, magnetic recording devices, bar codes or electrical circuits that contain a number of resonant circuits. These tags can be energized and/or interrogated by an RF signal, a microwave signal or an electrical or magnetic field, or by other suitable methods. Micron Communications or Biomark of Boise Id. and Texas Instruments of Dallas Tex. manufacture typical RFID tags.

An interrogator is used to probe the active or passive transponder. In the usual operation, the interrogator “illuminates” the transponder. The transponder will then respond with a signal that uniquely identifies the transponder and, in some cases, with further information, such as temperature or glucose readings, for example.

The interrogator is linked to another electronic mechanism that can convert the transponder's signal information to usable data. This data collector usually takes the form of a data/computer interface. If a specific unique identification code is sent to the interrogator, pre-loaded data such as the identity or origin of the specific object may be obtained. In animals, this data can include the name, weight, birth date, origin, or owner of the animal, for example. If this technology were to be used in humans, a person's personal data could be readily integrated with the system to provide the user of properly programmed interrogator nearly instantaneous detailed information on the person who was “illuminated.” Providing this detailed information may or may not be desirable. It is a prime object of this invention to allow a person the option to grant or deny access to an implanted transponder.

The concept of using passive transponders to identify humans is not far-fetched science fiction. With the already accepted use of such implantable transponders in animals the technology now exists to use the same methods to identify humans. Voluntary implantation of RFID devices in humans has already occurred and is the subject of over fifty US patents. For example, U.S. Pat. No. 7,125,382 issued to Zhou in 2006 describes a biosensor system that utilizes radio frequency identification technology. The biosensor system is specifically adapted to monitor a physiological parameter of a patient using wireless communication with an implanted transponder. U.S. Pat. No. 6,481,140 discloses a transponder voluntarily implanted into a gun owner's hand for use in association with one or more guns. The transponder is unique and allows access to the firing mechanism of a pistol only when the implanted transponder is in close proximity to the gun.

Obviously, there are good and bad uses for human-implanted RFID identifying tags. It could be useful to use such tags for children, for example. If the child were kidnapped, an appropriately placed interrogator could readily identify him or her. On the other hand, a person having an implanted identification transponder would sacrifice a great deal of personal privacy. Such a person could be readily identified at, for example, an airport or shopping mall. This surreptitious identification process could be quiet and virtually undetectable. It would be an advantage if illumination by an interrogator could be made known automatically to the person with the transponder. It is another object of this invention to allow a person having an implanted identification transponder to automatically be made aware that an interrogation of his or her transponder is about to take place.

In many instances, a person having an implanted transponder would like to permit access, in particular and limited situations, to the unique identifiers in the transponder. For example, if the transponder were implanted to give the person access to a high security area, the person would allow the interrogator to gain access to the identification data. On the other hand, in many situations (such as random checks at a mall or sports event) the person may want to either deny access to the foreign interrogator or to hide the presence of the implanted transponder altogether. It is a still further object of this invention to allow a person having an implantable identifying transponder to either deny access to an interrogator or to hide the presence of the transponder altogether.

Other and further objects of this invention will become obvious upon reading the below described specification.

### BRIEF DESCRIPTION OF THE DEVICE

A radio frequency identification device (RFID) is integrated with an electrical muscle stimulator and an electromyographic sense amplifier to produce a specialized implantable RFID tag. When the identification tag is illuminated, a warning in the form of a slight muscle stimulus is transmitted to the human's muscles. The human may then decide whether or not to allow the electronic interrogation to proceed. The Control Logic of the transponder is programmed to receive a command from the human. The human response command could be in the form of another muscle contraction, or a set of specified muscle movements. One set of human muscle contractions could give the command to allow the interrogation. A different set of muscle contractions could give the command to deny access. If access were denied, the interrogator would read “no transponder present.”

### BRIEF DESCRIPTION OF THE DRAWING

The drawing figure is a schematic block diagram of the invention showing the Permission Based RFID system.

### DETAILED DESCRIPTION OF THE PREFERRED EMBODIMENT

An implantable passive transponder 1 has three main components, a magnetic coil (antenna) 2, two muscle electrodes 7 and an integrated circuit. In the block diagram, everything located within the block 1 (the implanted tag) is integrated into a single chip except the antenna 2. The integrated circuit comprises elements of unique identifying information, a power recovery circuit, a muscle stimulator, an EMG amplifier and control logic. The integrated circuit, physically a small microchip, is of standard design and features. Using existing and well-known methods, these components are packaged in a manner suitable for implantation into the subject human. This packaging usually includes a sanitary and biologically safe material such as the glass transponder manufactured by Biomark, Inc. other encapsulating materials include ceramic or metal exteriors. The muscle electrodes are normally made of titanium or platinum.

The implantable transponder or tag 1 described herein is a passive transponder, although the disclosure of this invention could also be applied to active tags. The description of the tag as “passive” is meant as a disclosure of the preferred embodiment only and is not meant to be a limitation on the scope of this new invention. However, a passive tag can be manufactured in a much smaller since size it has no battery or other power source. Due to the miniaturization aspects of a passive transponder, it is more suitable for human implantation. The passive tag 1 collects all of its operating power from the magnetic (used at low frequencies of 10-500 kHz) or electromagnetic field (used at RF frequencies of 400 MHz-2 GHz). The reader or interrogator emanates the power. Typically, a coil wound around a ferrite core, commonly known as an antenna 2, collects the power.

When an external reader (interrogator) 10 attempts to interrogate the implanted tag (transponder), it illuminates the human with a magnetic or electromagnetic field. The magnetic coil of the antenna 2 produces an electrical current from which power is recovered by the power recovery circuit 3. The power recovery circuit 3 is part of the integrated circuit design of the implanted unit. Such circuits vary widely depending on use, but are well known in the art. The power recovery circuit 3 provides power for all circuits within the implanted tag. The integrated circuit (IC) also contains the unique identifying subject information 4 that is protected from unwanted intrusion by this invention.

Under normal operating conditions heretofore known in the art, the identifying information 4 of the tag 1 is transmitted to the reader once the tag is illuminated and the circuit energized. However, this invention discloses an electronic security method that prevents transmission of the unique identifying information until certain conditions are met. The operative conditions to release the information, or to deny access to it, are described below and constitute the novel disclosure of this specification.

The IC contains control logic 5. Once the subject is notified that his transponder has been illuminated, the control logic 5 holds the unique identifying information 4 until certain conditions are met. The subject controls these conditions. The subject may either permit or deny access to the information based on muscle responses.

Once power is applied to the tag 1 (by the external reader) 10, the control logic 5 becomes aware that an external reader 10 is attempting to interrogate the tag. The control logic 5 commands the muscle stimulator 6 to apply the stimulus to the subject's muscles.

The muscle stimulator 6 is also part of the IC. Muscle stimulators are well known in the art. As used in this device, a muscle stimulator sends small electrical currents to muscle electrodes 7. At least two muscle electrodes are needed to practice this device. The small stimulation of the muscle is the warning or alert signal that notifies the human carrier that his transponder has been illuminated and that an attempt is being made by an outside interrogator to access the unique identifying information contained in the transponder. The stimulus would consist of a train of electrical impulses that produce mild contractions of the subject's muscle. The cadence of the alert stimulus pulses is chosen to produce an easily identifiable yet harmless sensation in the subject. The sensation would be similar to the vibrating alert of a cell phone, but the source of the vibration would be located within the human subject. Once the subject is alerted to the attempt to read the unique identifying information of the tag, the subject can respond to either allow or deny access to the identifying information by flexing one or more muscles in one or more patterns.

The electromyographic sensors of the muscle electrodes are in intimate contact with a selected voluntary muscle, typically in one of the subject's extremities such as the forearm. Electromyographic sensors detect small signals resulting from the contractions of muscles. EMGs are a well-understood phenomenon of muscle tissue. When a given muscle contracts, a small corresponding electrical signal occurs. An electromyogram sensor is well understood in the art can detect such a signal. Such sensors typically provide an output voltage that corresponds to the strength of the musculature electrical signal. Two muscle electrodes will measure different voltages. The difference between the two voltages is measurable and can be used to make this devices function as described. EMGs will provide signals of varying maximum magnitudes when placed in contact with virtually any muscle.

EMG sensor technology has been used with positive results in many different fields, but most particularly in the field of paralysis. Humphrey describes a system, method and device for controlling external devices (for example, prosthesis, roots or robotics, and for the stimulation off muscles of paralyzed individuals) by signals derived from very small sensors or an array of sensors in U.S. Pat. No. 6,171,239. Humphrey uses bundles of six to ten small (20-50 micrometers in diameter) insulated and flexible noble metal wires as muscle electrodes. The various components of such a system are described in the Humphrey specification and other patents. Humphrey has a detailed description of the EMG sensors and electrodes, electronic microchips, external receivers and demultiplexers and the electronic methods used to shape and calibrate the signals.

For a discussion of the well known electronic characteristics of a circuit that uses EMGs to send wireless muscle signals to an external reader see the U.S. Pat. No. 7,148,878 issued to Hong.

An EMG amplifier 8 is also included in the integrated circuit of the device. Between and after the alert stimulus, the EMG amplifier 8 works to detect voluntary muscle contractions of the subject's muscle. The control logic 5 of the implanted tag can thereby measure the subject's voluntary response to the alert stimulus. The control logic 5 may be programmed in a variety of different ways to carry out this invention. For example, the control logic could be programmed to recognize a specific sequence or cadence of voluntary muscle contractions to confirm that the subject is consciously responding to the alert stimulus. The voluntary muscle contraction cadence could be as simple as a single contraction such as that produced by clenching a fist. Alternatively, it could be required that the contraction sequence be an arbitrarily long sequence of contractions of pre-specified duration and time spacing. The subject could even be required to spell out a word in Morse code by clenching a fist in a certain sequence for certain durations (dot and dash) before the control logic would recognize the response. This additional layer of security would be particularly useful in preventing manipulation of an unconscious individual.

Once the control logic has recognized a subject response in the form of voluntary muscle contractions, two operational modalities exist: Allow read or Deny read. The subject's response to the control logic through the EMG amplifier 8 would determine which of the two states is acceptable.

The transponder unit communicates with the external reader 10 by the data transmitter 9. The data transmitter 9 is also part of the integrated circuit design.

The interrogator (reader) 10 includes sufficient radiated power to energize the transponder at the desired read rates, sufficient bandwidth to interrogate the device in a reasonable amount of time, sufficient sensitivity to accurately obtain the device response and a suitable interface to a computer to record and update a database. Energizing the transponder device can be accomplished by transmitting an electromagnetic (DC, wave or field) or acoustic signal in the form of a continuous wave, pulsed cw wave, chirped waveform, spread-spectrum waveform, impulse or coded waveform.

When a certain specified signal is sent (as, for example two short clinches of the fist followed by one of longer duration) a “Permit Read” modality is given and the control logic would release the unique identifying information to the external reader via the data transmitter.

If, on the other hand, the subject gives the control logic the signal to deny read (such as, for example, by sending one short fist clinch and two long fist clinches) the control logic will prevent an otherwise automatic release of the identifying information.

The implantable transponder device described herein is the preferred embodiment of the device. The basic new and novel concept of this invention consists in giving the human subject the option to allow or deny access to information found on an identifying implanted tag. Generally, the use of an identifying and readable implantable transponder containing an antenna and a specialized microchip, powered by an external interrogator/reader, is known in the art. However, adding the circuit elements that allow the subject to grant or deny access to the information contained in the transponder by voluntary muscle contractions is new. Using this method of RFID control it is nearly impossible for an external reader to detect the presence of an implanted device if permission to read is denied by the subject.

It is to be appreciated that the specification herein is meant as an illustration only and not as a limitation. The concept of subject control of the implanted information can also be used with active transponders. It can also be utilized if the reader is hard wired to the identifying device and with varying modes of energizing the identifying device.

I claim:

1. An implantable transponder system for a human subject capable of being read by an external reader, comprising:
(a) an antenna;
(b) an integrated circuit electrically connected to said antenna comprising identifying information, power recovery, control logic, a muscle stimulator, an EMG amplifier and a data transmitter;
(c) at least two muscle electrodes having EMG sensors, said electrodes being electrically connected to said integrated circuit and in intimate contact with at least one muscle of said subject.

2. An implantable transponder system for a human subject capable of being read by an external reader as in claim 1, wherein said transponder is powered by radiation from said external reader.

3. An implantable transponder system for a human subject capable of being read by an external reader as in claim 1, wherein said control logic stimulates at least one muscle of a subject when said transponder is illuminated by an external reader.

4. An implantable transponder system for a human subject capable of being read by an external reader as in claim 1, wherein said control logic allows or denies the external reader access to said identifying information after receiving a signal from said subject.

5. An implantable transponder system for a human subject capable of being read by an external reader as in claim 4, wherein said signal is generated when the subject contracts at least one of said muscles in a set pattern.

6. An implantable transponder system for a human subject capable of being read by an external reader as in claim 1, further comprising two or more muscle electrodes.
